(19) United States
(12) Patent Application Publication
(10) Pub. No.: US 2011/0136035 A1
(43) Pub. Date: Jun. 9, 2011

(54) FUEL CELL USING UV CURABLE SEALANT

(76) Inventors: Sochenda P. Mao, New Britain, CT (US); Valerie N. Moses, Windsor, CT (US); Tommy Skiba, East Hartford, CT (US); Eric R. Strayer, West Hartford, CT (US)

(21) Appl. No.: 13/057,609

(22) PCT Filed: Sep. 23, 2008
(86) PCT No.: PCT/US2008/077303

§ 371 Date: Feb. 4, 2011

(51) Int. Cl. H01M 2/08; H01M 8/02; H01M 8/24

(52) U.S. Cl. 429/469; 429/535

(57) ABSTRACT

A fuel cell is disclosed that includes a cathode, an anode and an electrode assembly, each including lateral surfaces that adjoin one another. The electrode assembly is arranged between the cathode and anode. Each of the cathode, the anode and the electrode assembly include perimeter surfaces transverse to the lateral surfaces that are arranged adjacent to one another. A UV curable sealant is arranged on the perimeter surfaces providing a seal over the lateral surfaces. After the UV curable sealant has been applied to the perimeter surfaces, the sealant is exposed to a UV light source for a desired duration to cure the sealant. Accordingly, the UV curable sealant reduces the complexity of the cell stack assembly and decreases its production time.

### BACKGROUND

This disclosure relates to sealing the components of a fuel cell stack assembly, which includes an anode, a cathode and an electrode assembly.

Traditional fuel cell stack assembly designs use interfacial seals between the components of the cell stack assembly. Each cell includes an anode, a cathode and an electrode assembly. A fuel cell typically includes dozens or more cells arranged to provide the cell stack assembly. As a result, up to a hundred or more interfacial seals are used, which takes a considerable time to arrange within the cell stack assembly. Moreover, due to the large number of interfacial seals, the likelihood of a leak occurring past the seals is increased.

In particular, the interfacial seals are arranged between the lateral sides of the anode, the cathode and the electrode assembly to prevent the fuel and oxidant from escaping their respective flow fields thereby bypassing the electrode assembly and intermixing undesirably with one another. The interfacial seals typically take approximately twenty-fours hours to cure at room temperature. The interfacial seals cure time can be reduced to approximately one hour at elevated temperatures. Due to the cure time length, production time is rather lengthy for the fuel cell stack assembly, which increases overall manufacturing costs for the fuel cell.

What is needed is a seal design and method that reduces the cell stack assembly complexity and production time.

### SUMMARY

A fuel cell is disclosed that includes a cathode, an anode and an electrode assembly, each including lateral surfaces that adjoin one another. The anode and the cathode lateral surface include flow fields. No interfacial seals are used between the lateral surfaces in one example. The electrode assembly is arranged between the cathode and anode. Each of the cathode, the anode and the electrode assembly include perimeter surfaces transverse to the lateral surfaces that are arranged adjacent to one another. A UV curable sealant is arranged on the perimeter surfaces providing a seal over the lateral surfaces, which prevents fuel and oxidant in the flow fields from leaking out past the formed seal. After the UV curable sealant has been applied to the perimeter surfaces, the sealant is exposed to a UV light source for a desired duration to cure the sealant.

Accordingly, the UV curable sealant reduces the complexity of the cell stack assembly and decreases its production time.

### BRIEF DESCRIPTION OF THE DRAWINGS

The disclosure can be further understood by reference to the following detailed description when considered in connection with the accompanying drawings wherein:

FIG. 1 is a highly schematic view of an example fuel cell.

FIG. 2 is a cross-sectional view of a cell sealed with a UV curable sealant.

FIG. 3 is a schematic view of a system and method of sealing a cell stack assembly with the UV curable sealant.

### DETAILED DESCRIPTION

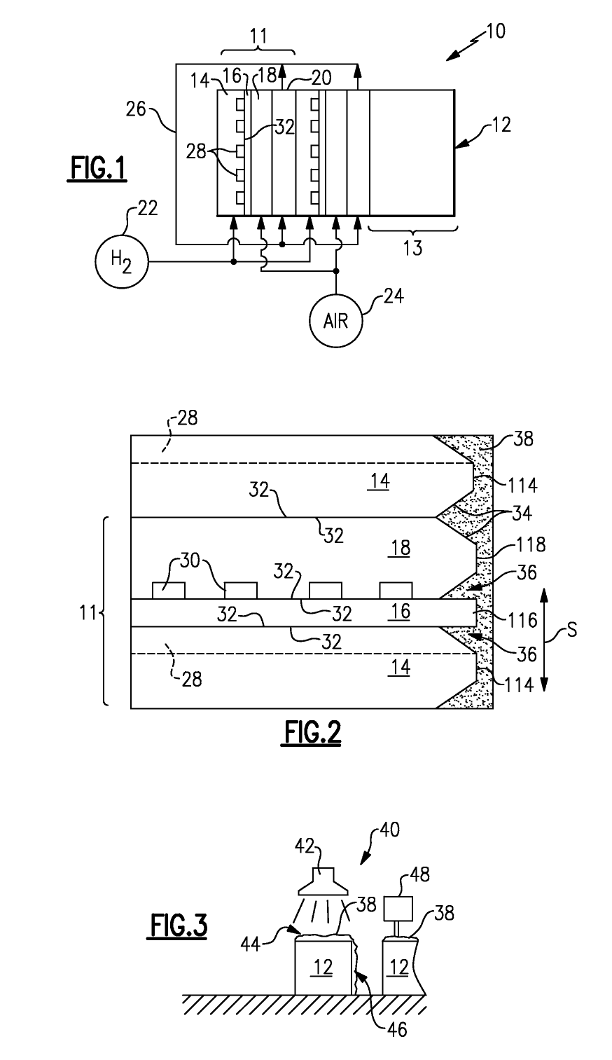

A highly schematic view of a fuel cell 10 is shown in FIG. 1. The fuel cell 10 includes multiple cells 11 that provide a cell stack assembly 12. Each cell 11 includes an electrode assembly 16 arranged between an anode 14 and a cathode 18. Additional cells 13 are schematically shown as part of the cell stack assembly 12.

Each cell 11 typically includes a coolant flow field 20 that may be provided by a separate structure or integrated into one of the components of the cell 11. Each anode 14 includes a fuel flow field 28 that is in fluid communication with a fuel source 22. The fuel source 22 is hydrogen, in one example. The cathodes 18 provide an oxidant or reactant flow field 30 (best shown in FIG. 2) that is in fluid communication with an oxidant or reactant source 24. In one example, the oxidant is provided by air. The coolant flow field 20 may include a coolant loop 26 for circulating coolant within the cell stack assembly 12 to maintain the fuel cell 10 at or below a desired operating temperature.

Referring to FIG. 2, the anode 14, the electrode assembly 16 and the cathode 18 include lateral surfaces 32 that adjoin one another to provide joints. Hydrogen from the fuel flow field 28 must be prevented from mixing with air from the oxidant flow field 24, such as by bypassing the electrode assembly 16. To this end, interfacial seals have been used between the anode 14, electrode assembly 16 and cathode 18 to seal the lateral surfaces 32 relative to one another. In the example disclosed, an ultraviolet (UV) curable sealant 38 is used to seal the fuel and oxidant flow fields 28, 30 from one another by sealing the joint between the anode 14 and the cathode 18 relative to the electrode assembly 16. In the example shown in FIG. 2, the anode 14, electrode assembly 16 and cathode 18 respectively include perimeter surfaces 114, 116, 118 that are transverse to the lateral surfaces 32 arranged at the outside of the cell stack assembly 12. The UV curable sealant 38 is applied over the perimeter surfaces 114, 116, 118 to provide a seal over the lateral surfaces 32 to prevent hydrogen or air from escaping the fuel and oxidant flow fields 28, 30. In the example shown, the lateral surfaces 32 are arranged in abutting engagement with one another.

With continuing reference to FIG. 2, the anode 14 and the cathode 18 include chamfers 34 adjoining the lateral surfaces 32 and the perimeter surfaces 114, 118 to provide gaps 26 at the joints. The UV curable sealant 38 is arranged within the gaps 36 as well as over the perimeter surfaces 114, 116, 118. The chamfers 34 provide additional surface area, which may improve the provided seal. Moreover, the additional sealant provided in the gaps 36 reduces the effects of vibration and flexural or thermal movements. Furthermore, the additional surface provided by the chamfers 34 increases bonding as well as giving an opposing surface and stress to the shear stress direction S.

A sealing system and method is shown schematically in FIG. 3. The system 40 includes a UV light source 42 for providing UV light to cure the UV curable sealant 38. A cell stack assembly 12 includes a horizontal side 44 to which an application device 48 applies the UV curable sealant 38. The application device 48 may be, for example, a robotically operated syringe or squeegee that generally evenly applies the UV curable sealant 38 to the horizontal side 44. Applying the UV curable sealant 38 to the horizontal side 44 as opposed to another side 46 enables the UV curable sealant to self-level. After the UV light has been applied to the UV curable sealant 38 for a desired duration, the cell stack assembly 12 is repositioned so that the other side 46 is arranged in a generally horizontal orientation to receive the UV curable sealant 38. All four sides of the cell stack assembly 12 receive the UV curable sealant 38. The ends of the cell stack assembly 12 do not need to be sealed.

The UV curable sealant 38 may be a urethane or an epoxy material, for example. The UV curable sealant 38 is selected to have desired viscosity and cure rates. One example UV curable material cures at an ambient temperature in less than several minutes.

Although example embodiments have been disclosed, a worker of ordinary skill in this art would recognize that certain modifications would come within the scope of the claims. For that reason, the following claims should be studied to determine their true scope and content.

What is claimed is:

1. A fuel cell comprising:
an electrode assembly arranged between a cathode and an anode, the anode and cathode respectively including fuel and oxidant flow fields;
a UV curable sealant arranged over the anode, cathode and electrode assembly separating the fuel and oxidant flow fields.

2. The fuel cell according to claim 1, wherein the anode, the cathode and the electrode assembly each include lateral surfaces in adjoining relation relative to one another, the fuel and oxidant flow fields provided on the lateral surfaces of the anode and cathode respectively, the anode, the cathode and the electrode assembly including perimeter surfaces arranged transverse to the lateral surfaces, the UV curable sealant arranged on the perimeter surfaces.

3. The fuel cell according to claim 2, comprising multiple cells providing a cell stack assembly, each cell including an anode, a cathode and an electrode assembly, the UV curable sealant provided on the cell stack assembly.

4. The fuel cell according to claim 2, comprising a shear stress direction, the perimeter surfaces arranged or generally parallel with the shear stress direction.

5. The fuel cell according to claim 2, comprising chamfers adjoining the perimeter and lateral surfaces, the chamfers providing a gap with the UV curable sealant disposed within the gap.

6. The fuel cell according to claim 2, wherein the lateral surfaces do not include interfacial seals arranged between the lateral surfaces.

7. A method of sealing a cell stack assembly comprising the steps of:
arranging an electrode assembly between an anode and a cathode forming joints therebetween;
applying sealant to a perimeter of the electrode assembly, the anode and the cathode across the joints; and
exposing the sealant to an ultraviolet light for a desired duration to cure the sealant.

8. The method according to claim 7, wherein the applying step includes arranging a generally horizontal side beneath an application device, and applying the sealant to the horizontal side.

9. The method according to claim 7, comprising arranging another side in a generally horizontal orientation beneath the application device prior to applying the sealant.

10. The method according to claim 7, wherein the applying step includes leveling the sealant on the perimeter surfaces.

11. The method according to claim 10, wherein the applying step includes applying sealant to gaps at the joints provided between the anode, the cathode and the electrode assembly.
